(19) United States
(12) Patent Application Publication
(10) Pub. No.: US 2025/0016606 A1
(43) Pub. Date: Jan. 9, 2025

(54) PRIORITY CALCULATION DEVICE, PRIORITY CALCULATION METHOD, AND STORAGE MEDIUM STORING PRIORITY CALCULATION PROGRAM

(71) Applicant: Mitsubishi Electric Corporation, Tokyo (JP)

(72) Inventors: Tatsuya YOKOYAMA, Tokyo (JP); Takahisa YAMAUCHI, Tokyo (JP); Masaaki TAKEYASU, Tokyo (JP); Shingo RYU, Tokyo (JP); Takashi ASAHARA, Tokyo (JP); Shusaku UMEDA, Tokyo (JP); Mari OCHIAI, Tokyo (JP); Takeshi SUEHIRO, Tokyo (JP)

(73) Assignee: Mitsubishi Electric Corporation, Tokyo (JP)

(21) Appl. No.: 18/891,338

(22) Filed: Sep. 20, 2024

Related U.S. Application Data
(63) Continuation of application No. PCT/JP2022/017322, filed on Apr. 8, 2022.

(51) Int. Cl. H04W 28/02; H04W 72/56

(52) U.S. Cl. CPC H04W 28/0263; H04W 28/0273; H04W 72/56

(57) ABSTRACT

An associating unit associates area identification information for identifying each of a plurality of monitoring areas with collected data obtained within each of the plurality of monitoring areas. A converting unit converts a set of a plurality of the collected data associated with the identical area identification information into traffic flow information indicating a traffic situation for each of the plurality of monitoring areas as a unit. A calculating unit calculates a priority for allocating a communication resource for each of the plurality of monitoring areas by using the traffic flow information.

### CROSS REFERENCE TO RELATED APPLICATION

This application is a Continuation of PCT International Application No. PCT/JP2022/017322, filed on Apr. 8, 2022, which is hereby expressly incorporated by reference into the present application.

### TECHNICAL FIELD

The present disclosure relates to a priority calculation device, a priority calculation method, and a priority calculation program.

### BACKGROUND TECHNOLOGY

To realize autonomous driving, there is a method to use panoramic view information, which is information integrating data collected from sensors with road maps. When using the panoramic view information, it is preferable to be able to prioritize distribution of the panoramic view information to an area at risk.

As a conventional technology, there is an information collecting device that includes: an collecting unit to collect sensor data transmitted from a plurality of in-vehicle devices through a base station by wireless communication; a generating unit to generate the panoramic view information from the sensor data collected by the collecting unit; a traffic participant identifying unit to identify a plurality of traffic participants and their locations by analyzing the sensor data; a monitoring area identifying unit to identify a monitoring target in accordance with a traffic situation from among the plurality of traffic participants identified by the traffic participant identifying unit, and a monitoring target area of a predetermined size including a location of the monitoring target; a priority determining unit to determine priority of the in-vehicle devices installed on the plurality of vehicles from positional relationships between the plurality of vehicles which are the traffic participants each having the respective in-vehicle devices installed and the monitoring target areas; and a transmitting unit to transmitting to the base station an instruction for adjusting wireless communication resources to be allocated to each of the plurality of in-vehicle devices in accordance with results of the determination by the priority determining unit, wherein the traffic participants include vehicles and people (for example, Patent Documents 1).

### PRIOR ART REFERENCES

### Patent Documents

[Patent Documents 1] Japanese Unexamined Patent Application Publication No. 2020-095504

### SUMMARY OF THE INVENTION

### Problems to be Solved by the Invention

The information collecting device described above identifies an area of the monitoring target of a predetermined size including an area at risk (hereinafter referred to as monitoring area), and calculates the priority of each in-vehicle device from the positional relationships with the monitoring area.

This allows the panoramic view information to be distributed preferentially to an in-vehicle device closer to the monitoring area at risk. However, the information collecting device mentioned above does not disclose how it calculates the priority in the case where there is more than one monitoring area to be the target. If there is a plurality of monitoring areas, the panoramic view information should be distributed preferentially to the monitoring areas that are at higher risk.

The present disclosure is designed to solve the above problem and allow the priority calculation among the plurality of monitoring areas.

### Means for Solving the Problems

A priority calculation device according to the present disclosure includes: a receiving unit to receive collected data obtained within each of a plurality of monitoring areas; an associating unit to associate area identification information for identifying each of the plurality of monitoring areas with the collected data; a converting unit to convert a set of a plurality of the collected data associated with the identical area identification information into traffic flow information indicating a traffic situation for each of the plurality of monitoring areas as a unit; and a calculating unit to calculate a priority for allocating a communication resource for each of the plurality of monitoring areas by using the traffic flow information.

### Effects of the Invention

The priority calculation device according to the present disclosure associates the area identification information with the collected data from the communication devices in the monitoring areas, and converts a set of a plurality of the collected data associated with the identical area identification information into the traffic flow information with each of the plurality of monitoring areas as a unit. This allows the priority calculation to be performed for each of the monitoring areas as a unit. Thus, even when there is a plurality of monitoring areas, the panoramic view information can be preferentially distributed to the monitoring areas that are at higher risk.

### BRIEF DESCRIPTION OF DRAWINGS

FIG. 1 shows a relationship between cells and monitoring areas according to Embodiment 1.

FIG. 2 shows a communication system according to Embodiment 1.

FIG. 3 shows a hardware configuration diagram of a communication device according to Embodiment 1.

FIG. 4 shows a hardware configuration diagram of an edge server according to Embodiment 1.

FIG. 5 shows a functional configuration diagram of the edge server according to Embodiment 1.

FIG. 6 shows traffic flow information according to Embodiment 1.

FIG. 7 shows calculation results of communication band congestion level according to Embodiment 1.

FIG. 8 shows calculation criteria of priority according to Embodiment 1.

FIG. 9 shows the calculation results of the priority according to Embodiment 1.

FIG. 10 shows allocation of communication resources according to Embodiment 1.

FIG. 11 is a flowchart showing an operation of the edge server according to Embodiment 1.

FIG. 12 shows a functional configuration diagram of an edge server according to Embodiment 2.

FIG. 13 shows a functional configuration diagram of an edge server according to Embodiment 3.

FIG. 14 shows a clustering result by a learning unit according to Embodiment 3.

FIG. 15 shows associated information according to Embodiment 3.

FIG. 16 shows a functional configuration diagram of an edge server according to Embodiment 4.

FIG. 17 shows a functional configuration diagram of an edge server according to Embodiment 5.

FIG. 18 shows tolerance values as determined by 5QI values for Variation 2.

### EMBODIMENTS FOR IMPLEMENTING THE INVENTION

### Embodiment 1

Embodiment 1 will be described in detail below with reference to the drawings.

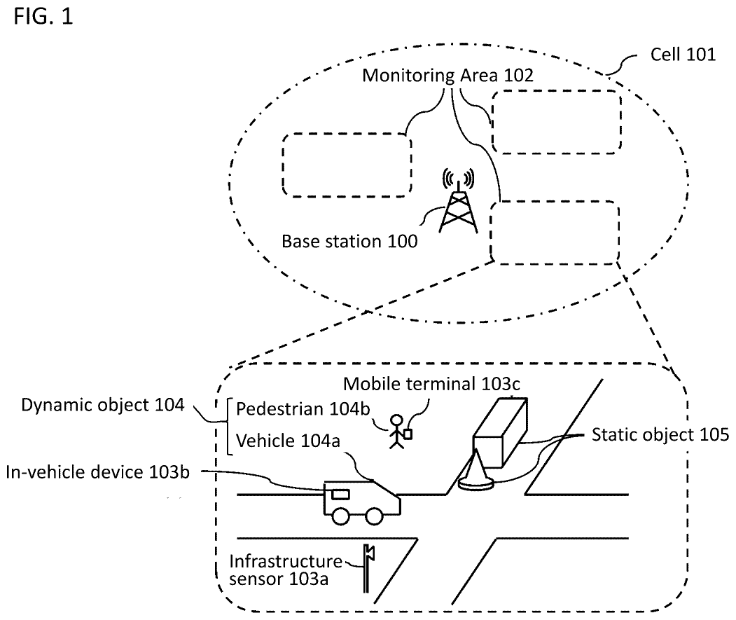

FIG. 1 shows a relationship between cells and monitoring areas according to Embodiment 1.

A base station 100 has a coverage area in which it is capable of wireless communication. This area is referred to as a cell 101. In other words, Embodiment I takes a wireless communication method, commonly referred to as a cell method, as an example.

Within the cell 101, N monitoring areas 102 are predetermined, where N is an integer greater than or equal to 2. The monitoring areas 102 are predetermined to contain traffic spaces that are considered likely to require driving assistance. In Embodiment 1, as shown in FIG. 1, one of the monitoring areas 102 is determined to include an intersection of roads and the surrounding area. The reason is that the intersection is risky and more likely to cause a traffic accident. Therefore, driving assistance is considered necessary to prevent traffic accidents. In addition to a public road, the traffic space may be a highway or a private property such as a factory or a parking lot. The shape of the area may be circular, rectangular, polygonal, or the like.

Within the monitoring area 102, there is an infrastructure sensor 103a, a vehicle 104a, a pedestrian 104b, and a static object 105.

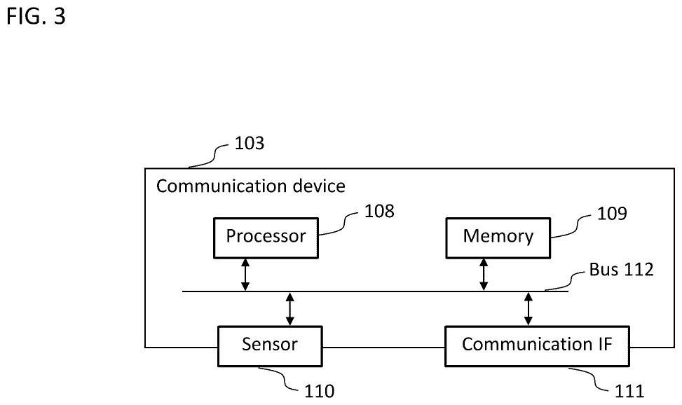

The infrastructure sensor 103a is located closer to the road and uses a sensor 110 (shown later in FIG. 3), which it incorporates, to collect data from the surroundings. For example, the infrastructure sensor 103a is equipped with a camera, a radar, and a light detection and ranging device (Lidar) as the sensor 110 to collect data about objects in the surrounding traffic space. Here, the monitoring areas 102 should be determined to overlap with the sensing range of the infrastructure sensor 103a. This reduces the possibility of an incorrect priority calculation due to a failure to detect the situation within the monitoring area 102. The detectable range and resolution of the sensors 110 such as camera, radar, and Lidar vary depending on the type of the sensor. Therefore, the range of each monitoring area 102 may be set to a different and appropriate range, taking into account the type of the sensor 110 to be equipped by the infrastructure sensor 103a. In addition, the infrastructure sensor 103a includes, for example, a temperature sensor, a humidity sensor, and a luminance sensor as the sensor 110 to collect environmental data such as weather and luminosity. Furthermore, the infrastructure sensor 103a includes, for example, a global positioning system (GPS) receiver to generate data about its own location.

The vehicle 104a is, for example, a car, a motorcycle, or a bicycle. The vehicle 104a is equipped with an in-vehicle device 103b and a sensor 110. The sensor 110 equipped by the vehicle 104a is the same as the sensor 110 equipped by the infrastructure sensor 103a. However, as the sensor 110 to be equipped by a moving object, an azimuth sensor, a speed sensor, and an acceleration sensor may be additionally listed. The in-vehicle device 103b may use the panoramic view information described below to perform the autonomous driving.

The pedestrian 104b carries a mobile terminal 103c. The mobile terminal 103c is equipped with the sensor 110. The examples of the sensor 110 to be equipped by the mobile terminal 103c are the same as those of the vehicle 104a.

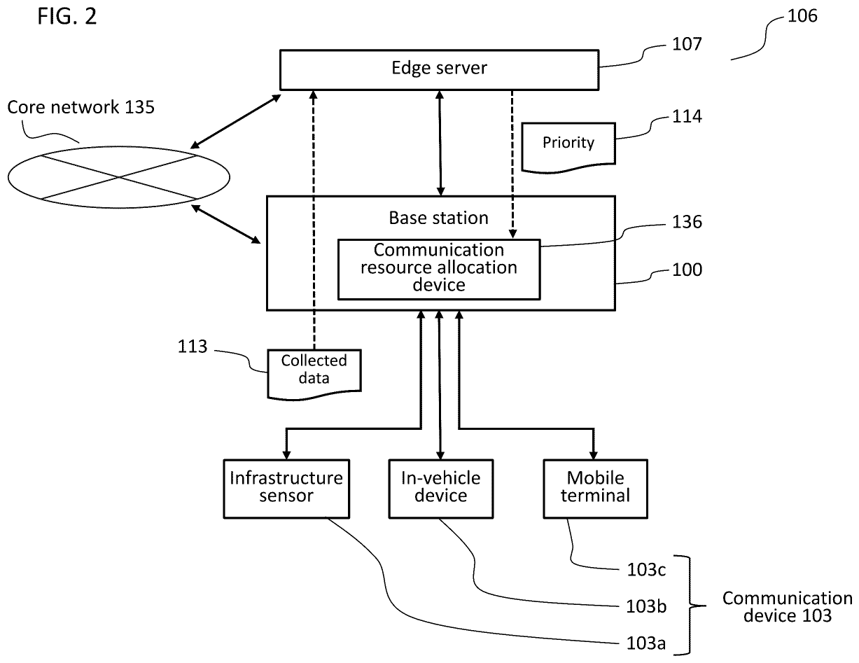

FIG. 2 shows a communication system according to Embodiment 1. The communication system 106 includes a core network 135, an edge server 107, the base station 100, the infrastructure sensor 103a, the in-vehicle device 103b, and the mobile terminal 103c. The base station 100 includes a communication resource allocation device 136. In the present disclosure, the infrastructure sensor 103a, the in-vehicle device 103b, and the mobile terminal 103c are collectively referred to as communication device(s) 103.

The core network connects to the base station 100 and the edge server 107. The core network relays the base station 100 or the edge server 107 to another base station or the Internet, not shown in FIG. 2, as needed. Such relaying is a communication method that is already commonly realized in the world, and its description will be omitted here. Instead, the following description will focus on how to adjust communication resources using the collected data.

Each of the communication devices 103 uploads the collected data 113, which is the data having been collected, to the edge server 107 via the base station 100. The collected data 113 includes sensor data, which is the data obtained by the device's own sensor 110, device data, which is the data about the communication device itself that is stored in advance, and the date and time of obtaining these data. The sensor data includes data about the types, locations, speeds, directions, and sizes of other dynamic objects 104 and static objects 105 in its vicinity, as well as data about the environment, such as weather and luminosity. The device data includes data about the location, speed, direction, and size of the device itself. Here, the dynamic objects 104 are, for example, the vehicle 104a in motion, the pedestrian 104b, and animals. The static objects 105 are, for example, the vehicle 104a not in motion, construction equipment placed on the ground, and an object left on the ground.

The communication device 103 as the in-vehicle device 103b may include information on the type, status, and control content of the vehicle 104a equipped with the communication device 103 in the collected data 113. The type of vehicle is a type, such as emergency vehicle, priority vehicle, and general vehicle. The status of vehicle indicates, for example, whether it is in an autonomous driving mode or in a manual driving mode. The vehicle control content includes, for example, the pedal depth of the accelerator or brake, the angle of the steering wheel (i.e., vehicle's wheels), and the ON/OFF status of the turn signals.

The edge server 107 uses the collected data 113 uploaded by the communication devices 103 to calculate the priority 114 for each of the plurality of monitoring areas 102 and transmits it to the communication resource allocation device 136. The edge server 107 may also distribute the panoramic view information, described later, to the communication devices 103 located within each monitoring area 102. The edge server 107 is, for example, a multi-access edge computing (MEC) server, which is being standardized by the European Telecommunications Standards Institute (ETSI). Note that the edge server 107 corresponds to the priority calculation device.

The base station 100 relays communication between the communication devices 103 within the cell 101 and the edge server 107. In addition, the base station 100 controls communication with the communication devices 103 in accordance with the result of the allocation of the communication resources by the communication resource allocation device 136.

The communication resource allocation device 136 allocates the communication resources in accordance with the priority 114 received from the edge server 107. In Embodiment 1, the communication resources to be allocated are resources for wireless communication between the base station 100 and the communication devices 103. Note that the communication method used by the communication devices 103 in the present disclosure is not limited to wireless communication via the base station 100. For example, because the infrastructure sensor 103a is located close to the road, the communication device 103 equipped by the infrastructure sensor 103a may be connected to the edge server 107 via a wired network. In this case, the allocation of the communication resources may be performed for the wired communication resources between the edge server and the communication devices. In other words, the allocation of the communication resources in the present disclosure is not limited to those related to the wireless communication.

FIG. 3 shows a hardware configuration diagram of the communication devices 103 according to Embodiment 1. Each communication device 103 includes a processor 108, a memory 109, the sensor 110, a communication IF 111 (IF stands for interface), and a bus 112. The processor 108, the memory 109, the sensor 110, and the communication IF 111 transmit and receive signals to and from each other via the bus 112.

The processor 108 is, for example, a central processing unit (CPU), a digital signal processor (DSP), a graphical processing unit (GPU), or a field-programmable gated array (FPGA).

The memory 109 is, for example, a static random access memory (SRAM), a dynamic random access memory (DRAM), or a read-only memory (ROM). If the storage capacity of the memory 109 alone is insufficient, the communication devices 103 may be equipped with an auxiliary storage device, not shown, if necessary. The auxiliary storage device is, for example, a hard disk drive (HDD) or a solid state drive (SSD).

The sensor 110 is, for example, a camera, a radar, a LiDAR, a temperature sensor, a humidity sensor, a luminance sensor, a GPS receiver, an azimuth sensor, a speed sensor, or an acceleration sensor.

The communication IF 111 is, for example, a cellular communication module. In Embodiment 1, an example is shown in which the communication IF 111 performs the wireless communication. However, in the present disclosure, the communication IF 111 may perform the wired communication. In that case, the communication IF 111 is a device that complies with, for example, the IEEE 802.3 standard.

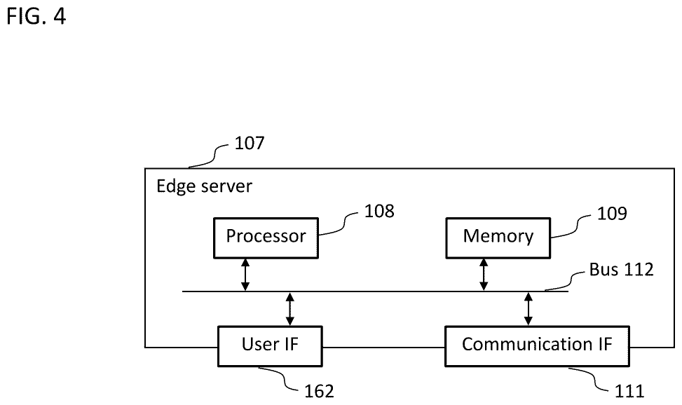

FIG. 4 shows a hardware configuration diagram of the edge server 107 according to Embodiment 1.

The edge server 107 includes a processor 108, a memory 109, the communication IF 111, a user IF 162, and a bus 112. Components common to the communication devices 103 are omitted from the description. The user IF 162 is, for example, a keyboard, a mouse, or a display.

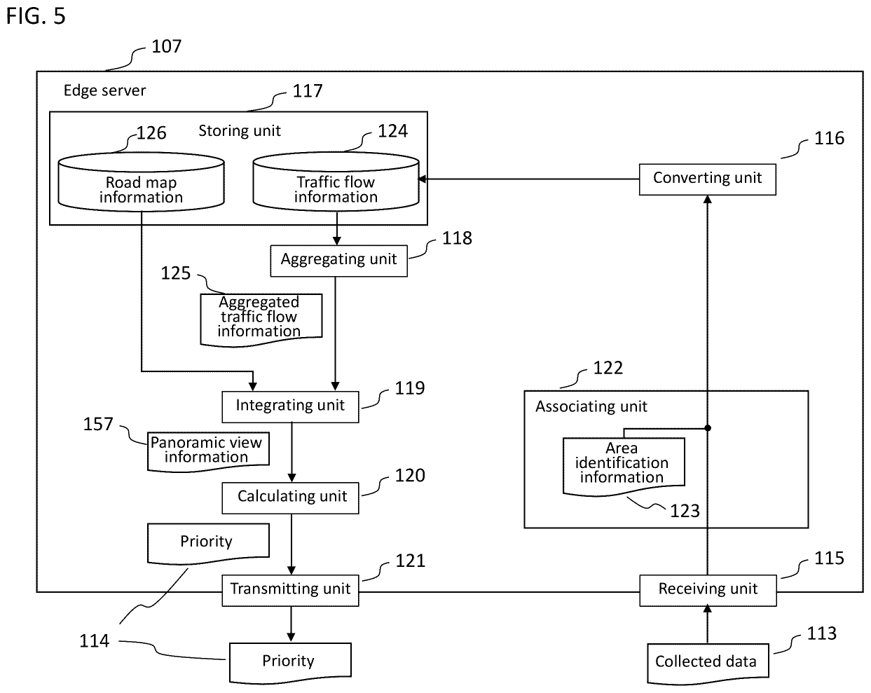

FIG. 5 shows a functional configuration diagram of the edge server 107 according to Embodiment 1. The edge server 107 includes a receiving unit 115, an associating unit 122, a converting unit 116, a storing unit 117, an aggregating unit 118, an integrating unit 119, a calculating unit 120, and a transmitting unit 121. The receiving unit 115 and the transmitting unit 121 are implemented as the communication IF 111. The associating unit 122, the converting unit 116, the aggregating unit 118, the integrating unit 119, and the calculating unit 120 are implemented as the processor 108. The storing unit 117 is implemented as the memory 109.

The receiving unit 115 receives the collected data 113 from the communication devices 103 and transmits the data to the associating unit 122.

For the collected data 113, the associating unit 122 generates and associates area identification information 123 indicating the monitoring area 102 where the communication device 103 from which the collected data 113 was uploaded is located, and transmits the information to the converting unit 116. The area identification information is information that identifies each of the plurality of monitoring areas 102, for example, commonly referred to as an ID.

For example, as a method for the association, the storing unit 117 stores in advance the range of each monitoring area as latitude and longitude information. The associating unit 122 refers to the location information included in the collected data 113 to identify which monitoring area 102 the communication device 103 being the transmission source of the corrected data 113 is located in.

For example, as another method for the association, the storing unit 117 stores in advance information that associates infrastructure sensor identification information identifying the infrastructure sensor 103a with the area identification information 123. When the collected data 113 is data from the infrastructure sensor 103a, the receiving unit 115 refers to the information associating the infrastructure sensor identification information with the area identification information 123 to generate the area identification information 123 in accordance with the infrastructure sensor identification information included in the collected data 113, and provides the generated information to the collected data 113. When the collected data 113 is data from the in-vehicle device 103b, the associating unit 122 compares the location information of the in-vehicle device 103b included in the collected data 113 with the location information of the infrastructure sensor 103a included in the data uploaded by the infrastructure sensor 103a to determine which monitoring area 102 the in-vehicle device 103b is located in, generates the area identification information 123 and provides the generated information to the data uploaded by the in-vehicle device 103b. When the collected data 113 is from the mobile terminal 103c, the associating unit 122 generates and provides the area identification information 123 using the same method as in the case of the data from the in-vehicle device 103b.

The converting unit 116 converts the collected data 113 received from the associating unit 122 into traffic flow information 124 to store it in the storing unit 117. The traffic flow information 124 is information that views the movements of the vehicle 104a and the pedestrian 104b within each of the plurality of monitoring areas 102 as a flow of a group, rather than as individual movements. The converting unit 116 converts a set of the collected data 113 associated with the identical area identification information 123 into the traffic flow information with the targeted monitoring area 102 as a unit. For example, the converting unit 116 compiles a plurality of the collected data 113 associated with area_id_1 to convert the set to the traffic flow information of the monitoring area 102 corresponding to the area_id_1.

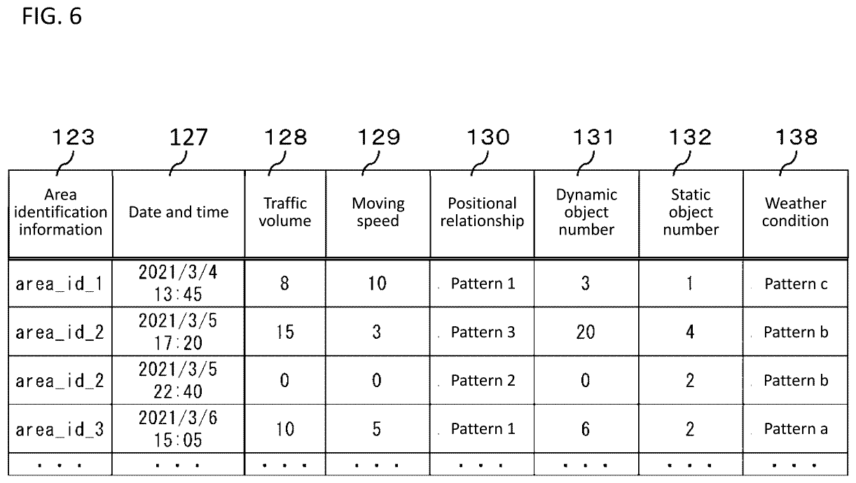

FIG. 6 shows the traffic flow information 124 according to Embodiment 1. The traffic flow information 124 is information in which the area identification information 123, a date and time 127, a traffic volume 128, a moving speed 129, a positional relationship 130, a dynamic object number 131, a static object number 132, a weather condition 138 are associated with each other.

The area identification information 123 is an ID prefixed with “area_id_” to indicate the monitoring area 102 to which the information relates. The date and time 127 indicates the date and time the information was collected. The traffic volume 128 is an amount of traffic of the vehicle 104a and the pedestrian 104b traveling within the area per unit of time. The moving speed 129 is a moving speed of the vehicle 104a and the pedestrian 104b within the monitoring area 102. The positional relationship 130 is positional relationships within the monitoring area 102 between the dynamic objects, between the static objects, or between the dynamic object and the static object. The positional relationship 130 may be represented as, for example, categorized patterns of numbers, locations, and the distances with respect to the vehicle 104a and the pedestrian 104b, etc., present in the monitoring area 102, wherein the distances are calculated from the locations. FIG. 6 shows an example with Pattern 1, Pattern 2, and Pattern 3 as the categorized patterns. The dynamic object number 131 is a number of the dynamic objects 104 within the monitoring area 102. The static object number 132 is a number of the static objects 105 within the monitoring area 102. The weather condition 138 is a condition of temperature, wind, etc. within the monitoring area 102. The weather condition 138 may also be categorized patterns. FIG. 6 shows an example with Pattern a, Pattern b, and Pattern c as the categorized patterns. In the example shown in FIG. 6, the traffic volume 128, the moving speed 129, the dynamic object number 131, and the static object number 132 take indexed values, but absolute values may also be taken.

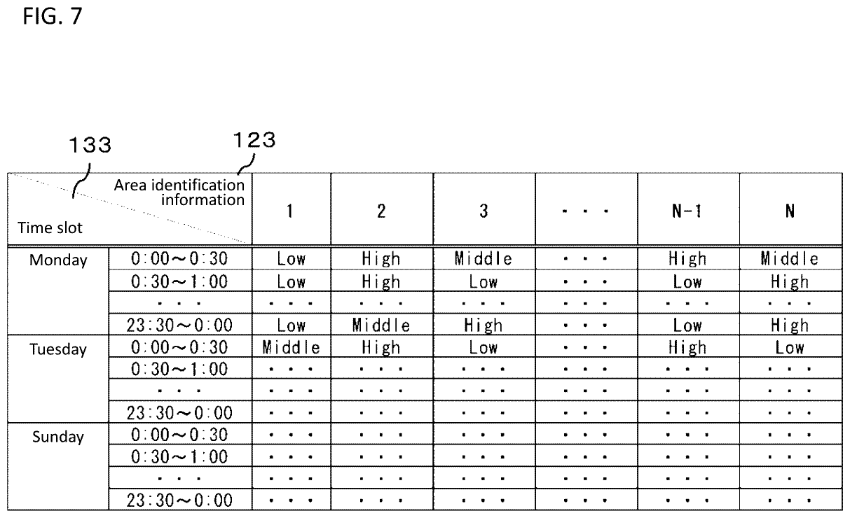

When the aggregating unit 118 determines that the traffic flow information 124 has sufficiently accumulated in the storing unit 117, it aggregates the accumulated information into statistical values for respective time slots. The time slots, given by dividing the time in a day, are, for example, 0:00 to 0:30, 0:30 to 1:00, . . . 23:30 to 0:00, if it is divided at regular intervals of every 30 minutes. For example, the time slots may be further distinguished by the day of the week or the month of the year as a unit (an example of distinguishing by the day of the week as a unit is shown in FIG. 7). The time slots do not have to be at regular intervals, and may be divided at different intervals from each other, for example, from 0:00 to 2:00 and from 17:00 to 17:15. The statistical value for each time slot is, for example, the total, mean, median, maximum, and minimum values of the traffic flow information 124 for each time slot.

The integrating unit 119 integrates aggregated traffic flow information 125 with road map information 126 stored in advance by the storing unit 117 to generate panoramic view information 157. The road map information 126 is information about a road map or a map within a private property. The panoramic view information 157 is information obtained by associating the aggregated traffic flow information 125 with the location information on the road map.

The calculating unit 120 uses the panoramic view information 157 to calculate indicators that include at least one of the three of a communication band congestion level of the communication devices 103, a degree of necessity for the traffic reconciliation, and a likelihood of a traffic accident occurring, for each monitoring area 102 by time slots. The traffic reconciliation refers to dynamic objects avoiding a collision (for example, a vehicle or pedestrian stopping to give way at an intersection, etc.).

The calculating unit 120 calculates the communication band congestion level of the communication devices 103 in accordance with the traffic volume 128 included in the panoramic view information 157. In addition, the calculating unit 120 calculates the degree of necessity for the traffic reconciliation in accordance with the moving speed 129, the positional relationship 130, the dynamic object number 131, and the static object number 132 included in the panoramic view information 157. Furthermore, the calculating unit 120 calculates the likelihood of a traffic accident occurring in accordance with the moving speed 129, the positional relationship 130, the dynamic object number 131, and the static object number 132 included in the panoramic view information 157.

FIG. 7 shows calculation results of the communication band congestion level of the communication devices 103 according to Embodiment 1. FIG. 7 sets the time slots 133 for the row classification and the area identification information 123 for the column classification to show the communication band congestion level of the communication devices 103 for each area identification information 123 and for each time slot 133. In the example of the time slots 133 shown in FIG. 7, time is distinguished by the day of the week as a unit, and then the time of each day is divided into 30 minute segments. The area identification information 123 takes a number from 1 to N to show the information for all the monitoring areas 102. The congestion level is the lowest when indicated as “Low” and the highest when indicated as “High”. “Middle” is between “Low” and “High”. Although FIG. 7 shows an example of dividing the congestion level into three stages, the requirements of the present disclosure are satisfied if at least two stages are provided. Alternatively, instead of stages, a continuous numerical value may be provided.

The degree of necessity for the traffic reconciliation and the likelihood of a traffic accident occurring take a format the same as that of the congestion level shown in FIG. 7, that is, a format of setting the time slots 133 for the row classification and the area identification information 123 for the column classification.

The calculating unit 120 calculates the allocation priority 114 of the communication resources for each monitoring area 102 in accordance with predetermined criteria on the basis of the calculated indicators.

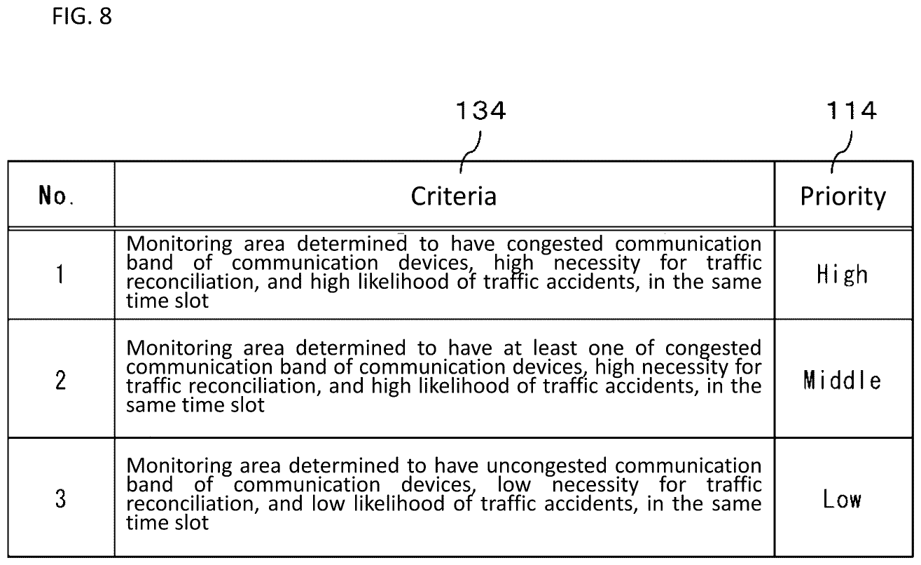

FIG. 8 shows the calculation criteria for the priority 114 according to Embodiment 1. The priority calculation criteria are information associating the criteria 134 and the priority 114. FIG. 8 includes three conditions as the criteria.

The first criterion 134 is whether the monitoring area 102 is determined to be an area where “the communication band of the infrastructure sensor 103a is congested” and also “the necessity for traffic reconciliation is high” and also “the traffic accident is likely to occur” in the same time slot 133. If this criterion is satisfied, “High” is calculated as the priority 114.

The second criterion 134 is whether the monitoring area 102 is determined to be an area where one or more of the conditions: “the communication band of the infrastructure sensor 103a is congested”, “the necessity for traffic reconciliation is high”, and “the traffic accident is likely to occur” are satisfied in the same time slot 133. If this criterion is satisfied, “Middle” is calculated as the priority 114.

The third criterion 134 is whether the monitoring area 102 is determined to be an area where “the communication band of the infrastructure sensor 103a is not congested” and also “the necessity for traffic reconciliation is low” and also “the traffic accident is unlikely to occur” in the same time slot 133. If this criterion is satisfied, “Low” is calculated as the priority 114.

Thus, the calculating unit 120 calculates the higher priority 114 as the necessity for traffic reconciliation is higher and the traffic accident is more likely to occur. In other words, the higher the risk of traffic flow within the targeted monitoring area 102, the higher the priority 114 calculated by the calculating unit 120.

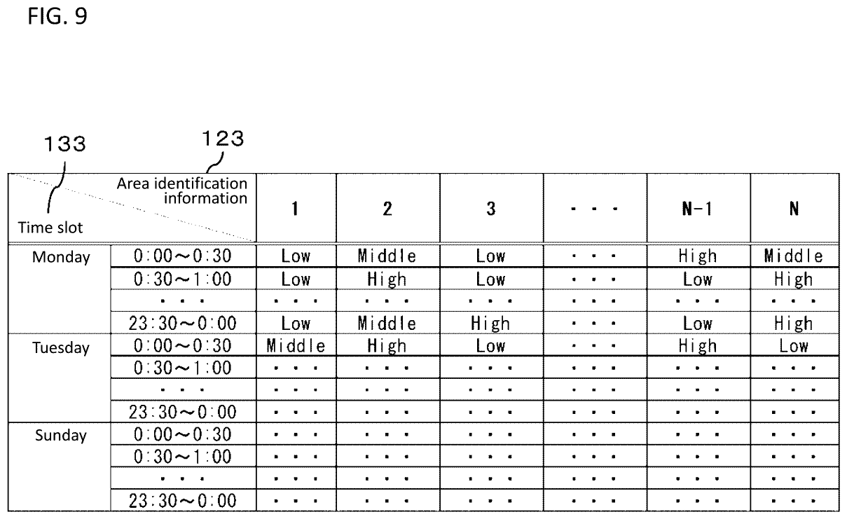

FIG. 9 shows calculation results of the priority 114 according to Embodiment 1. FIG. 9 has the same format as FIG. 7, i.e., the time slots 133 are set for the row classification and the area identification information 123 is set for the column classification. The priority 114 is the lowest when indicated as “Low” and the highest when indicated as “High”. “Middle” is between “Low” and “High”. Although FIG. 9 shows an example of dividing the priority 114 into three stages, the requirements herein are satisfied if at least two stages are provided. Alternatively, instead of stages, a continuous numerical value may be provided.

The transmitting unit 121 transmits the priority 114 calculated by the calculating unit 120 to the communication resource allocation device 136.

The communication resource allocation device 136 allocates the communication resources to the communication devices 103 located within the monitoring area 102 identified by the area identification information 123 by using the priority 114 received from the edge server 107.

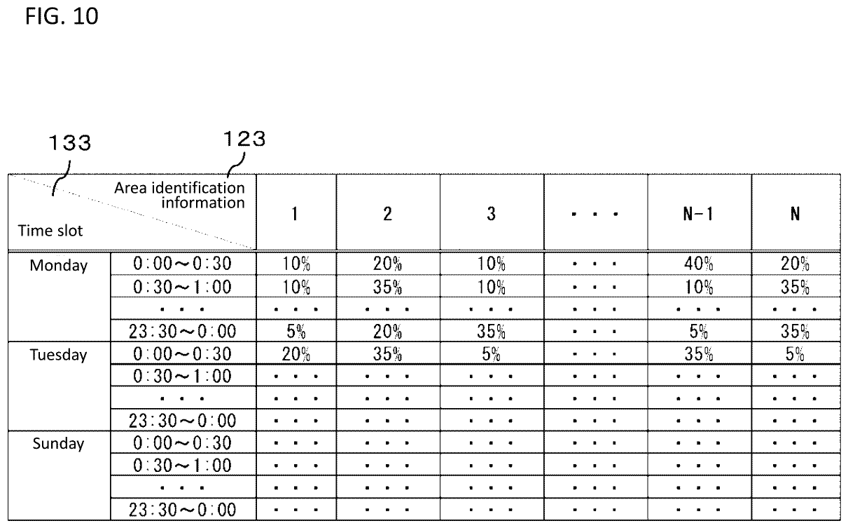

FIG. 10 shows the allocation of the communication resources according to Embodiment 1.

FIG. 10 has the same format as FIG. 7, i.e., the time slots 133 are set for the row classification and the area identification information 123 is set for the column classification. FIG. 10 shows percentage values for the allocation of the communication resources. The percentage values are allocated in such a manner that 100%, or 100% minus a margin (for example, 90%), is divided among the monitoring areas.

The base station 100 controls communication with the communication devices 103 in accordance with the communication resource allocation shown in FIG. 10. For example, the base station 100 changes items such as the time slots on the time axis divided by the time division multiple access (TDMA) method, the frequency slots on the frequency axis divided by the frequency division multiple access (FDMA) method, the modulation scheme such as BPSK, QPSK, 16QAM, 64QAM, 256QAM, and the resource blocks (blocks delimited on both the frequency and time axes) divided by the orthogonal frequency division multiple access (OFDMA) method.

Also, the base station 100 may control, for example, an amount of the collected data 113 or the upload frequency for the communication devices 103.

Specifically, the base station 100 instructs the communication devices 103 located within the monitoring area 102 with the higher priority 114 to increase the frequency of compiling and uploading the collected data 113 and instructs the communication devices 103 located within the monitoring area 102 with the lower priority 114 to decrease the frequency thereof. Alternatively, the base station 100 instructs the communication devices 103 located within the monitoring area 102 with the higher priority 114 to increase the resolution and refresh rate of the images of the sensor 110, such as a camera, and instructs the communication devices 103 located within the monitoring area 102 with the lower priority 114 to decrease the resolution and refresh rate.

The update timing for the priority 114 and the communication resource allocation may be set in advance as appropriate by, for example, an administrator of the edge server 107 and the communication resource allocation device 136 (hereinafter simply referred to as the administrator). The administrator may set different update timings for each of the monitoring areas 102.

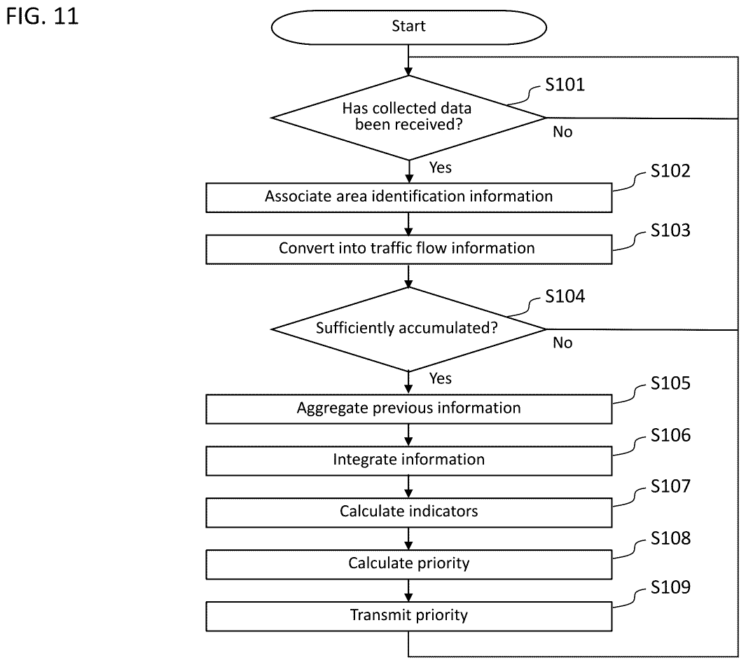

FIG. 11 is a flowchart showing an operation of the edge server 107 according to Embodiment 1.

When the receiving unit 115 receives the collected data 113 uploaded by the communication devices 103 (S101, Yes), the associating unit 122 associates the area identification information 123 with the collected data 113 (S102). If the receiving unit 115 has not received the collected data, the process returns to S101 (S101, No).

The converting unit 116 converts the collected data 113, to which the area identification information 123 was given by the associating unit, into the traffic flow information 124, and causes the storing unit 117 (S103) to store (accumulate) the converted traffic flow information.

If the aggregating unit 118 determines that the traffic flow information 124 has sufficiently accumulated in the storing unit 117 (S104, Yes), it aggregates the accumulated information into the statistic value for each time slot 133 (S105). If it is determined that the accumulation is insufficient (S104, No), the process returns to S101.

The integrating unit 119 integrates the aggregated traffic flow information 125 and the road map information 126 stored in advance by the storing unit 117 to generate the panoramic view information 157 (S106).

The calculating unit 120 uses the panoramic view information 157 to calculate the indicators including at least one of the following three: the communication band congestion levels of the communication devices 103, the degree of necessity for the traffic reconciliation, and the likelihood of a traffic accident occurring (S107), for each monitoring area 102 for each time slot 133.

The calculating unit 120 calculates the allocation priority 114 of the communication resources for each monitoring area 102 in accordance with predetermined criteria on the basis of the calculated indicators (S108).

The transmitting unit 121 transmits the priority 114 calculated by the calculating unit 120 to the communication resource allocation device 136 (S109). The edge server 107 returns to the process of S101 upon completion of S109.

As described above, the priority calculation device according to Embodiment 1 associates the area identification information 123, which is the information for identifying each of the plurality of monitoring areas 102, with the collected data 113, which is the data collected within each of the plurality of monitoring areas 102, and converts the set of the plurality of collected data 113 associated with the identical area identification information 123 into the traffic flow information 124, which is the information indicating the traffic situation for each of the monitoring areas 102 as a unit, and then, calculates the allocation priority 114 for the communication resources for each of the plurality of monitoring areas 102 by using the traffic flow information 124. This makes it possible for the priority 114 to be calculated for each monitoring area 102 as a unit. Therefore, even when there is the plurality of monitoring areas 102, the panoramic view information 157 can be preferentially distributed to the monitoring areas 102 that are at higher risk.

The calculating unit 120 calculates, from the traffic flow information 124, the indicators including at least one of the communication band congestion level of the communication devices 103, the degree of necessity for the traffic reconciliation, and the likelihood of a traffic accident occurring in each of the plurality of monitoring areas 102, wherein the higher the indicators, the higher the priority 114 is calculated. This allows saturation of the communication band in the infrastructure sensor 103a to be avoided, and allows the edge server 107 to continue compiling the collected data 113 from the infrastructure sensor 103a. In addition, the edge server 107 can preferentially compile the collected data 113 from the monitoring areas 102 requiring the driving assistance to generate and distribute the panoramic view information 157 to be used for the driving assistance to the communication devices 103 within the monitoring areas 102.

Also, the aggregating unit 118 aggregates the traffic flow information 124 for each time slot 133. This allows unusual traffic events that have occurred in the monitoring areas 102 to be removed as noise and improves the accuracy of the calculation of the priority 114.

### Embodiment 2

Embodiment 1 shows an example of using the traffic flow information 125 aggregated for each time slot 133. Next, Embodiment 2 shows an example in which current traffic flow information is also used, depending on the situation.

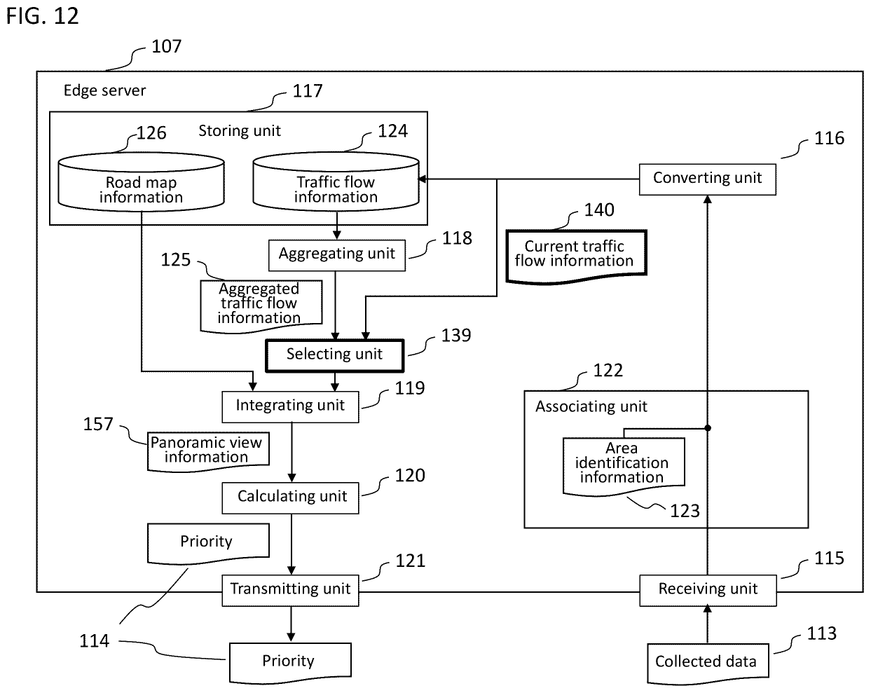

FIG. 12 is a functional configuration diagram of an edge server 107 according to Embodiment 2. The difference from Embodiment 1 is that it further includes a selecting unit 139. The selecting unit 139 is implemented as the processor 108. The selecting unit 139 selects the aggregated traffic flow information 125 when the discrepancy between the aggregated traffic flow information 125 and the current traffic flow information 140 is small, and conversely selects the current traffic flow information 140 when the discrepancy is large. The criteria for determining the magnitude of the discrepancy are, for example, whether the difference between the aggregated traffic flow information 125 and the current traffic flow information 140 exceeds a predetermined threshold. Another way is to use as a criterion the deviation of the current traffic flow information 140 obtained when the aggregated traffic flow information 125 is set as a population.

As described above, the priority calculation device according to Embodiment 2 selects the aggregated traffic flow information 125 when the discrepancy between the aggregated traffic flow information 125 and the current traffic flow information 140 is small, and selects the current traffic flow information 140 when the discrepancy is large. This allows a more suitable priority 114 to be calculated if an event (such as an accident) that is unusual in the normal situation occurs.

### Embodiment 3

As a method for calculating the three indicators from the traffic flow information, Embodiment 3 shows an example in which a model for clustering the traffic flow information 124 into a plurality of groups according to similarity performs machine learning and inputs of the indicator values for each group are accepted.

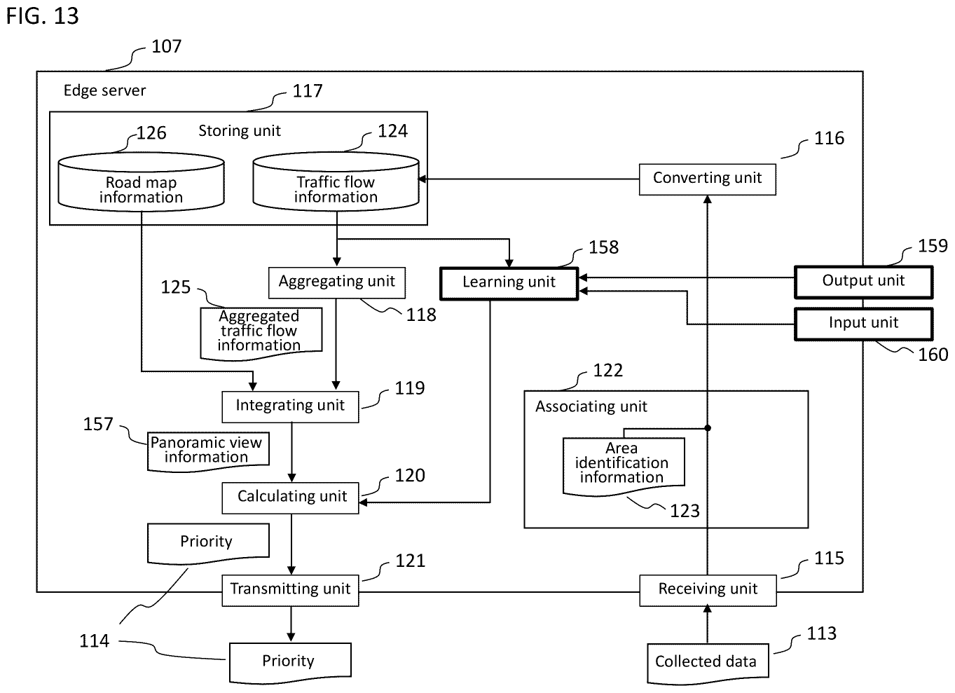

FIG. 13 is a functional configuration diagram of an edge server 107 according to Embodiment 3. The difference from Embodiment 1 is that the edge server 107 includes a learning unit 158, an output unit 159, and an input unit 160. The learning unit 158 is implemented as the processor 108. The output unit 159 and the input unit 160 are implemented as the user IF 162. The learning unit 158 learns the model for clustering the traffic flow information 124 stored by the storing unit 117 into one of the plurality of groups in accordance with the similarity. An existing clustering method, such as the k-means method, is used as the learning method.

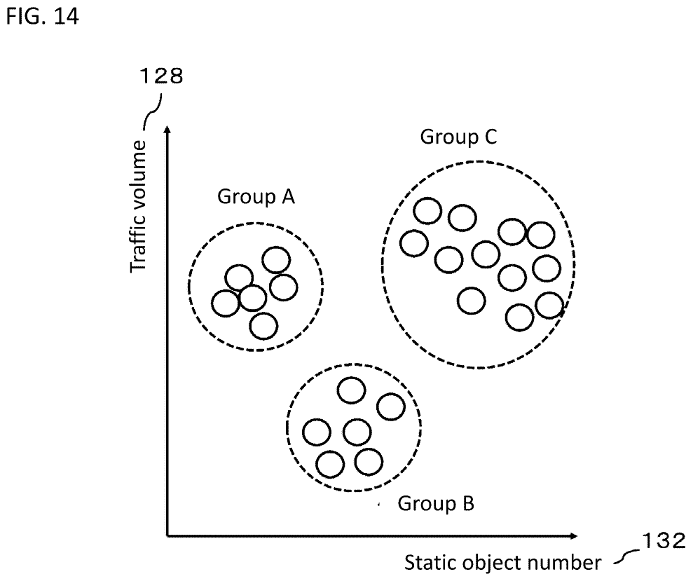

FIG. 14 shows clustering results by the learning unit 158 according to Embodiment 3. FIG. 14 shows a two-dimensional graph with the static object number 132 as the horizontal axis and the traffic volume 128 as the vertical axis, with a total of 24 spots plotted on the graph. Each of the 24 spots represents the traffic flow information 124. These 24 spots represent the information for six days for each of the four monitoring areas 102 in a given time slot 133. The learning unit 158 clusters the 24 traffic flow information 124 on the basis of the two variables of the static object number 132 and the traffic volume 128. The variables used for the clustering may be other variables (for example, the dynamic object number 131 and the weather condition 138), and the number of the variables may be an integer equal to or larger than 1.

FIG. 14 shows the clustering results, in which the information is clustered into Group A, Group B, and Group C. The edge server 107 displays the clustering results shown in FIG. 14 to the administrator through the output unit 159 (for example, a display device) and displays a message prompting the administrator to enter the indicator values for each of Group A, Group B, and Group C. The edge server 107 also accepts the administrator's inputs of the indicator values for each of Group A, Group B, and Group C through the input unit 160 (keyboard, mouse, etc.). That is, the input unit 160 accepts the input of associated information, which is information indicating the correspondence between the groups and the indicator values.

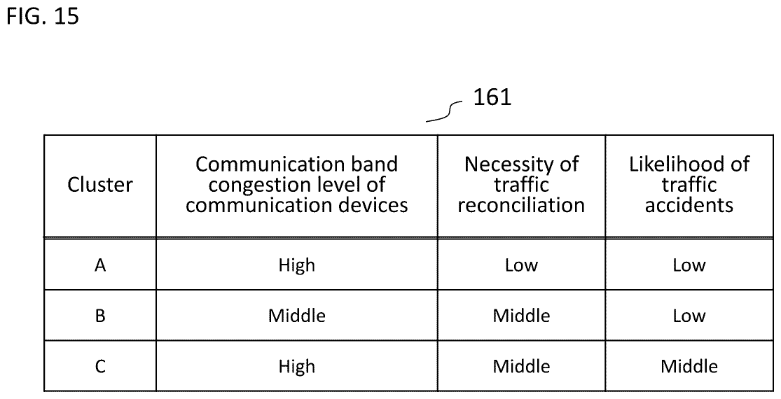

FIG. 15 shows the associated information according to Embodiment 3. In FIG. 15, a value (one of High, Middle, and Low) for the communication band congestion level of the communication devices 103, the degree of necessity for the traffic reconciliation, and the likelihood of a traffic accident occurring is associated with each of Group A, Group B, and Group C.

The learning unit 158 transmits the model learned by the clustering to the calculating unit 120. The calculating unit 120 uses the received model to determine into which group the traffic flow information 125 aggregated by the aggregating unit 118 should be clustered. The calculating unit 120 also uses the associated information 161 and determines the indicator values corresponding to the clustered groups to calculate the indicators from the aggregated traffic flow information 125.

As described above, the priority calculation device according to Embodiment 3 learns the model for clustering the traffic flow information 124 into one of the plurality of groups in accordance with the similarity, accepts the input of the associated information 161 indicating the correspondence between the groups and the indicator values, determines the groups into which the traffic flow information 124 should be clustered by using the model, and identifies the values of the indicators corresponding to the groups into which the traffic flow information is clustered by using the associated information 161 to obtain the indicators. This allows the indicators to be calculated in accordance with the characteristics of the traffic flow information 124 and improves the accuracy of the calculation of the priority 114.

### Embodiment 4

Embodiment 4 calculates the priority by using a traffic plan, which is a plan for transportation, in addition to the content of Embodiment 1. For example, in private properties, such as ports, factories, and parking lots, the times and locations of traffic activities occurring within the facilities, such as transporting, loading/unloading of goods, and turning the vehicle 104a around, etc., are planned in advance. For example, even on public roads, especially in urban areas, the times and locations of bus operation are often planned in advance. Such a plan for transportation is referred to as a traffic plan in the present disclosure.

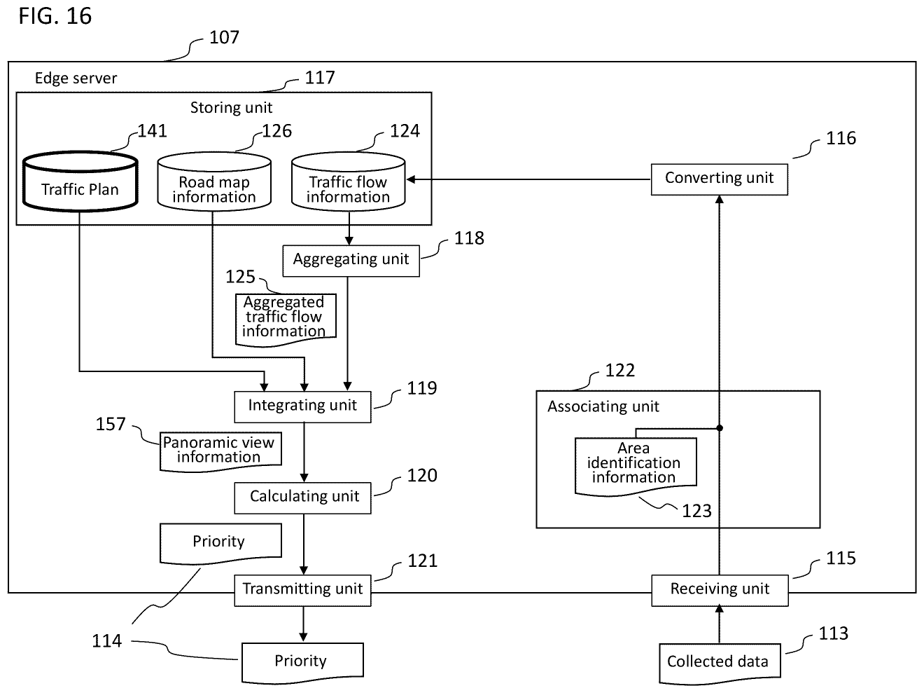

FIG. 16 shows a functional configuration diagram of an edge server 107 according to Embodiment 4. The present embodiment differs from Embodiment 1 in that the storing unit 117 stores a traffic plan 141 in advance. The integrating unit 119 associates the aggregated traffic flow information 125, the road map information 126, and the traffic plan 141 on the basis of the times and locations to generate the panoramic view information 157. The calculating unit 120 uses the panoramic view information 157, into which the traffic plan 141 is integrated as described above, to calculate the three indicators (the communication band congestion level of the communication devices 103, the degree of necessity for the traffic reconciliation, and the likelihood of a traffic accident occurring). For example, in the case where cargo transportation or bus stoppage is planned as the traffic plan 141, the degree of necessity for the traffic reconciliation and the likelihood of a traffic accident occurring are estimated higher.

As described above, the priority calculation device according to Embodiment 4 associates the road map information 126 and the traffic plan 141 with the accumulated traffic flow information 125 to use them for calculating the indicators. This allows the calculation of indicators that consider the traffic plan 141 made in advance and improves the accuracy of the calculation of priority 114.

### Embodiment 5

Embodiment 5 describes an example in which the edge server 107 according to Embodiment 1 includes a display unit to display the operating status of the edge server 107.

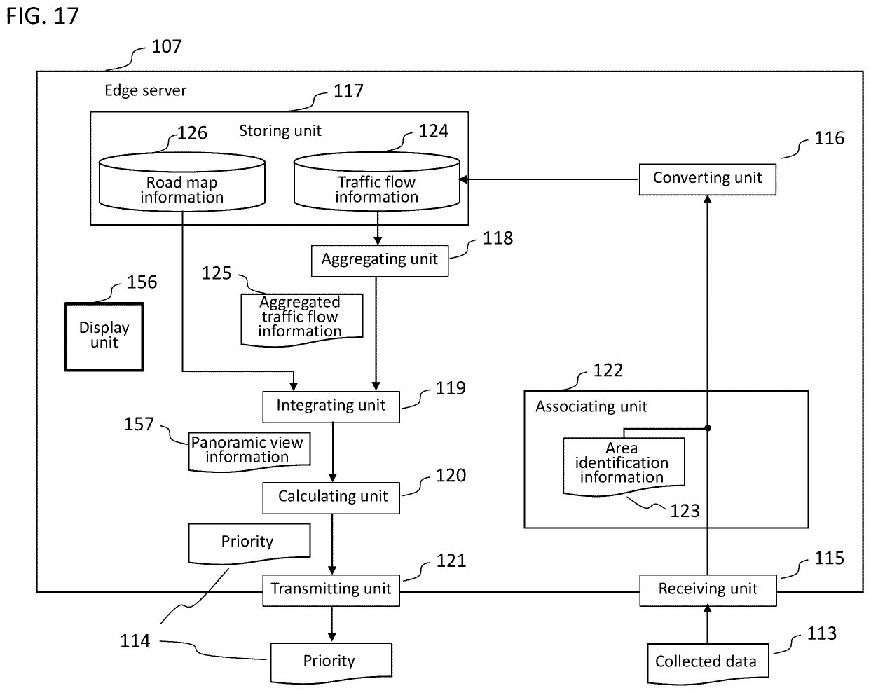

FIG. 17 shows a functional configuration diagram of the edge server 107 according to Embodiment 5. The difference from Embodiment 1 is that it includes a display unit 156. The display unit 156 is implemented as the user IF 162. The display unit 156 collects and displays the operating status of the edge server 107. For example, the means of display is a display device. The operating status of the edge server 107 is, for example, a history of inputs and outputs of information with respect to the receiving unit 115, the associating unit 122, the converting unit 116, the storing unit 117, the aggregating unit 118, the integrating unit 119, the calculating unit 120, and the transmitting unit 121, or a history of reading and writing of information with respect to the traffic flow information 124 and the road map information 126 stored in the storing unit.

The administrator checks the operating status of the edge server 107 displayed by the display unit 156 to determine whether the edge server 107 is operating properly. The administrator can make appropriate changes to the settings for the edge server 107 depending on the results of the determination. Appropriate changes to the settings allow the edge server 107 to operate normally and calculate the correct priority 114.

As described above, the priority calculation device according to Embodiment 5 collects and displays the contents of the inputs and outputs of information in each unit of the priority calculation device and the contents of the reading and writing of information stored in the storing unit. This allows the administrator to determine whether the priority calculation device is operating properly, make appropriate changes to the settings of the priority calculation device, and thus cause the priority calculation device to calculate the priority 114 correctly.

### <Variation 1>

Embodiment 1 shows an example in which the edge server 107 and the base station 100 are configured separately. However, in the present disclosure, the edge server 107 and the base station 100 may be housed in the same facility or enclosure. In that case, the edge server 107 and the communication resource allocation device 136 may be configured as one apparatus.

### <Variation 2>

The priority 114 may be, for example, a 5G QoS Indicator (5QI value) defined in the 3GPP (registered trademark) standard (TS23.501). The communication resource allocation device 136 may allocate the communication resources in accordance with tolerance values defined by the 5QI values.

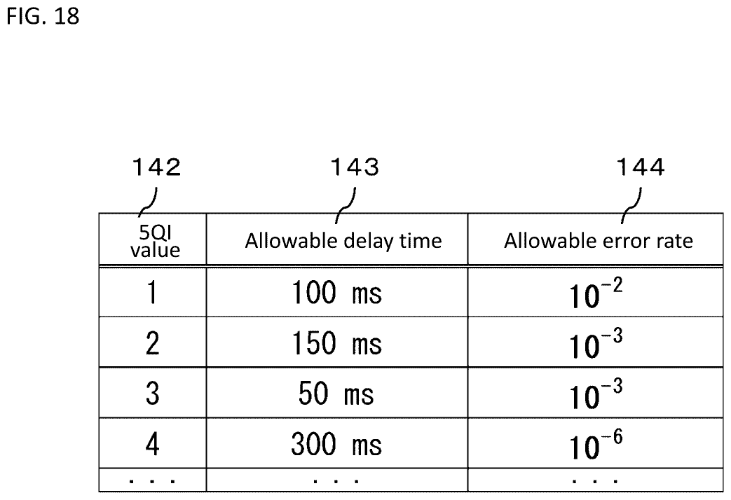

FIG. 18 shows the tolerance values defined by the 5QI values according to Variation 2. FIG. 18 shows information in which 5QI values 142, allowable delay times 143, and allowable error rates 144 are associated and enumerated. The allowable delay times 143 and the allowable error rates 144 correspond to the tolerance values. The allowable delay times 143 are delay times allowed in transmitting and receiving packets. The allowable error rates 144 are error rates that can be allowed in transmitting and receiving packets. The communication resource allocation device 136 may determine the tolerance values as specified according to the 5QI values 142 as shown in FIG. 18, and allocate the communication resources to satisfy the determined tolerance values.

### <Variation 3>

Embodiment 1 shows an example in which the edge server 107 calculates the priority 114 for each monitoring area 102 as a unit, i.e., an example in which the communication devices 103 located within the same monitoring area 102 are all subject to the uniform priority 114. However, the present disclosure is not limited to the above, and the priority for communication between the communication devices 103 located within the same monitoring area 102 may be calculated as a sub-priority. That is, hierarchical calculation of the priority is also possible, in which the priority 114 with the monitoring areas 102 as a unit is set as the main-priority, and the priority with the communication devices 103 as a unit is set as the sub-priority. Meanwhile, in the center of the monitoring area is a spot such as an intersection, etc., where traffic accidents are likely to occur. Therefore, to give an example for calculating the sub-priority, the edge server 107 allocates a higher priority to a communication devices 103 located closer to the center of the monitoring area. This allows more data to be collected regarding the areas that are considered to be more likely to cause traffic accidents and improves the accuracy of the calculation of priority 114.

### <Variation 4>

Another way for calculating the sub-priority is to calculate the sub-priority using the distance from a spot in which the traffic flow is likely to change within the monitoring area 102. The edge server 107 uses the panoramic view information 157 to determine the spot in which the traffic flow is likely to change within the monitoring area 102. For example, the spot in which the vehicle 104a is likely to make a lane change is determined. The edge server 107 allocates the higher priority 114 to the communication devices 103 located closer to the determined spot. This allows the edge server 107 to compile the collected data 113 about the spot in which the traffic flow is likely to change, and improves the accuracy of the calculation of the priority 114.

### <Variation 5>

Another way for calculating the sub-priority is to allocate the higher priority 114 to the in-vehicle devices 103b equipped by emergency vehicles. This allows the panoramic view information 157 required for the driving assistance to be preferentially distributed to the vehicles 104a responding to the emergency.

### <Variation 6>

Embodiment 1 shows an example in which the calculating unit 120 calculates the priority 114 using the panoramic view information 157 integrated by the integrating unit 119. However, the present disclosure is not limited to the above, and the priority 114 may be calculated using the aggregated traffic flow information 125 instead of the panoramic view information 157.

### <Variation 7>

Embodiment 1 shows an example in which the edge server 107 distributes the panoramic view information 157, described below, to the communication devices 103 located within each monitoring area 102. However, the present disclosure is not limited to the above, and the edge server 107 is not necessary to distribute the panoramic view information 157 to the communication devices 103. The scope of the present disclosure includes, for example, highway traffic control. The edge server 107 preferentially distributes to the traffic control center the traffic flow information 125 or the panoramic view information 157 relating to the monitoring areas 102 where the likelihood of a traffic accident occurring is high. The traffic control center displays the distributed traffic situation to the traffic controller. The traffic controller checks the displayed traffic situation and takes action if necessary, such as calling the highway patrol to dispatch a patrol car. In this way, the traffic controller can prioritize and check the information about the monitoring areas 102 where accidents are most likely to occur, and take action if necessary. As in the example above, the scope of the present disclosure is not limited to the domains in which the communication devices 103 are to receive the panoramic view information 157 from the edge server 107.

### <Variation 8>

Embodiment 1 shows an example in which the base station 100 instructs the communication devices 103 about the amount of collected data 113 and the upload frequency. However, the present disclosure is not limited to the above, and the communication devices 103 may receive the priority 114, and then adjust the amount of the collected data 113 and the upload frequency in accordance with the received priority 114.

### <Variation 9>

Embodiment 1 shows an example in which the update timing of the priority 114 is set in advance by the administrator. Assuming the cases where the in-vehicle device 103b performs the autonomous driving using the panoramic view information 157, Variation 9 shows an example in which the update timing of the panoramic view information 157, which is required to be distributed in the shortest cycle, and the update timing of the priority 114 are synchronized.

The panoramic view information 157 is information associating 3D spatial information, which is information that identifies, for each lane, the locations and shapes of the road as well as structures in the vicinity with assisting information, which is various types of information necessary to assist the autonomous driving. The assisting information is classified into dynamic information, semi-dynamic information, semi-static information, and static information. The dynamic information includes information transmitted by and exchanged between dynamic objects, such as vehicles and pedestrians, as well as traffic signal information, which requires the update frequency within one second as a unit. The semi-dynamic information includes information such as traffic congestion, temporary driving restrictions, temporary obstacle conditions such as falling objects or broken down cars, and accident conditions, which requires the update frequency within one minute. The semi-static information includes information such as traffic control information due to road construction or events, traffic congestion forecasts, etc., which requires the update frequency within one hour. The static information includes information about roads, structures, lanes, and road surfaces, which requires the update frequency within one month. Thus, the panoramic view information 157 requires different distribution (update) frequencies depending on the information it contains. Therefore, the priority 114 may be updated in synchronization with the update timing of the shortest cycle among the update timings of the panoramic view information 157 in each of the plurality of monitoring areas 102. This allows the priority 114 to be updated with sufficient frequency and the collected data 113 to be obtained appropriately from the monitoring areas 102 which require the short cycle update of the panoramic view information 157.

### <Variation 10>

Embodiment 1 shows an example in which the indicators and the panoramic view information 157 are primarily used to calculate the priority 114, but such information may be used by the in-vehicle devices 103b and the mobile terminals 103c. For example, the in-vehicle device 103b and the mobile terminal 103c may determine the monitoring areas 102 where traffic accidents are likely to occur on the basis of such information, and plan a travel route to avoid such monitoring areas 102.

### <Variation 11>

In Embodiment 1, the communication devices 103 generate data of their own locations using GPS receivers. However, the present disclosure is not limited to the above, and beacon signals obtained by near-field wireless communication may be used for positioning. For example, there is a technology based on Bluetooth that uses the beacon signals emitted by an apparatus placed in advance to locate the communication devices that receive the beacon signals.

### DESCRIPTION OF SYMBOLS

100 base station,
101 cell,
102 monitoring area,
103a infrastructure sensor,
103b in-vehicle device,
103c mobile terminal,
103 communication device,
104a vehicle,
104b pedestrian,
104 dynamic object,
105 static object,
106 communication system,
107 edge server,
108 processor,
109 memory,
110 sensor,
111 communication IF,
112 bus,
113 collected data,
114 priority,
115 receiving unit,
116 converting unit,
117 storing unit,
118 aggregating unit,
119 integrating unit,
120 calculating unit,
121 transmitting unit,
122 associating unit,
123 area identification information,
124 traffic flow information,
125 aggregated traffic flow information,
126 road map information,
127 date and time,
128 traffic volume,
129 moving speed,
130 positional relationship,
131 number of dynamic objects,
132 number of static objects,
133 time slot,
134 criterion,
135 core network,
136 communication resource allocation device,
137 input/output IF,
138 weather condition,
139 selecting unit,
140 current traffic flow information,
141 traffic plan,
142 5QI value,
143 allowable delay time,
144 allowable error rate,
156 display unit,
157 panoramic view information,
158 learning unit,
159 output unit,
160 input unit,
161 associated information,
162 user IF

1. A priority calculation device comprising:
a processor to execute a program; and
a memory to store the program which, when executed by the processor, performs processes of:
associating area identification information for identifying each of a plurality of monitoring areas with collected data obtained within each of the plurality of monitoring areas;
converting a set of a plurality of the collected data associated with the identical area identification information into traffic flow information indicating a traffic situation for each of the plurality of monitoring areas as a unit; and
calculating a priority for allocating a communication resource for each of the plurality of monitoring areas by using the traffic flow information.

2. The priority calculation device according to claim 1, wherein the program further performs processes of:
storing the converted traffic flow information;
aggregating the stored traffic flow information for each of time slots; and
selecting the aggregated traffic flow information when a discrepancy between the aggregated traffic flow information and converted current traffic flow information is small, and to select the converted current traffic flow information when the discrepancy is large, and
wherein, in calculating the priority, the selected traffic flow information is used.

3. The priority calculation device according to in claim 1, wherein, in calculating the priority, the traffic flow information is used to obtain an indicator that includes at least one of a communication band congestion level of an infrastructure sensor, a degree of necessity for traffic reconciliation, and a likelihood of a traffic accident occurring, for each of the plurality of monitoring areas, and to calculate the priority in such a manner that the higher the indicator, the higher the priority.

4. The priority calculation device according to claim 3, wherein the program further performs processes of:
leaning a model for clustering the traffic flow information into one of a plurality of groups in accordance with similarity; and
accepting an input of associated information indicating correspondence between the groups and values of the indicators, and
wherein, in calculating the priority, the model is used to identify a group into which the traffic flow information should be clustered and also the associated information is used to determine the value of the indicator corresponding to the clustered group, whereby the indicator is calculated.

5. The priority calculation device according to claim 3, wherein the program further performs processes of:
storing in advance road map information showing a road map and a traffic plan being a plan for transportation in each of the plurality of monitoring areas; and
generating panoramic view information associating the road map information and the traffic plan with the traffic flow information, and
wherein, in calculating the priority, the panoramic view information is used to obtain the indicator.

6. The priority calculation device according to claim 1, wherein the program further performs processes of:
storing the converted traffic flow information; and
collecting and displaying contents of inputs and outputs in each of the processes performed in the priority calculation device and contents of reading and writing of the stored information.

7. A priority calculation method comprising:
associating area identification information for identifying each of a plurality of monitoring areas with collected data obtained within each of the plurality of monitoring areas;
converting a set of a plurality of the collected data associated with the identical area identification information into traffic flow information indicating a traffic situation for each of the plurality of monitoring areas as a unit; and
calculating a priority for allocating a communication resource for each of the plurality of monitoring areas by using the traffic flow information.

8. A non-transitory storage medium storing a priority calculation program causing a computer to execute processes of:
associating area identification information for identifying each of a plurality of monitoring areas with collected data obtained within each of the plurality of monitoring areas;
converting a set of a plurality of the collected data associated with the identical area identification information into traffic flow information indicating a traffic situation for each of the plurality of monitoring areas as a unit; and
calculating a priority for allocating a communication resource for each of the plurality of monitoring areas by using the traffic flow information.
